(19) United States
(12) Patent Application Publication
(10) Pub. No.: US 2026/0357690 A1
(43) Pub. Date: Nov. 12, 2026

(54) SYSTEM AND METHOD FOR A RIG HOISTING MODEL

(71) Applicant: Schlumberger Technology Corporation, Sugar Land, TX (US)

(72) Inventors: Wei Chen, Katy, TX (US); Rongbing Chen, Beijing (CN); Yuelin Shen, Katy, TX (US); Zhengxin Zhang, Katy, TX (US); Jian Wu, Houston, TX (US); Guishui Zheng, Beijing (CN)

(21) Appl. No.: 19/200,762

(22) Filed: May 7, 2025

(51) Int. Cl. E21B 44/02; G05B 13/04

(52) U.S. Cl. CPC E21B 44/02; G05B 13/04; E21B 2200/20

(57) ABSTRACT

A method for operating a rig hoisting model is disclosed. The method includes receiving input data, determining an initial motor torque (Tₘₒₜₒᵣ) based on the input data, and determining an initial hookload based on a simulation of a drillstring. The method also includes determining a velocity (V_{TB}) of a traveling block based on the initial hookload and the initial Tₘₒₜₒᵣ, determining a predicted hookload based on the V_{TB}, and determining a current surface weight on bit (SWOB) based on the predicted hookload and a hookload at zero WOB. The method further includes determining a predicted linear velocity (V_{Drum}) at a drum based on a simulation of a rig hoisting system, determining a current rate of penetration (ROP) based on the predicted linear velocity at the drum (V_{Drum}), and operating the rig hoisting model based on the current ROP and the current SWOB.

### BACKGROUND

Hoisting systems are utilized in oil and gas drilling operations to enable the controlled lifting and lowering of heavy equipment, such as drill strings, casing, and bottom-hole assemblies. Modern or conventional hoisting systems often utilize or incorporate an autodriller to minimize fluctuations and/or maintain one or more drilling parameters during drilling operations. By minimizing fluctuations and/or maintaining the drilling parameters, the autodriller enables smoother drilling operations, particularly in transitions between formations, to thereby minimize wear of downhole tools and bits. Conventional oil and gas models used to simulate hoisting systems utilizing an autodriller, however, often rely on static assumptions (e.g., constant force and/or velocity), simplified physics, or incomplete representations of dynamic interactions between system components. As a result, these models often lack the fidelity to sufficiently predict real-world performance, thereby leading to suboptimal equipment design, relatively decreased control strategies, unexpected downtime, and increased operational risk.

What is needed, then, are improved models for simulating oil and gas hoisting systems and methods for the same.

### SUMMARY

A method for operating a rig hoisting model is disclosed. The method includes receiving input data. The method also includes determining an initial motor torque (Tₘₒₜₒᵣ) based on the input data. The method also includes determining an initial hookload based on a simulation of a drillstring. The method also includes determining a velocity (V_{TB}) of a traveling block based on the initial hookload and the initial Tₘₒₜₒᵣ. The method also includes determining a predicted hookload based on the V_{TB}. The method also includes determining a current surface weight on bit (SWOB) based on the predicted hookload and a hookload at zero WOB. The method also includes determining a predicted linear velocity (V_{Drum}) at a drum based on a simulation of a rig hoisting system. The method also includes determining a current rate of penetration (ROP) based on the predicted linear velocity at the drum (V_{Drum}). The method also includes operating the rig hoisting model based on the current ROP and the current SWOB.

Another method for operating a rig hoisting model is disclosed. The rig hoisting model includes a control model, a mechanical model, and a drillstring model operably coupled with one another. The method includes receiving input data at the control model. The method also includes determining an initial motor torque (Tₘₒₜₒᵣ) of the mechanical model with the control model based on the input data. The method also includes determining an initial hookload based on the drillstring model. The method also includes determining a velocity (V_{TB}) of a traveling block with the mechanical model based on the initial hookload and the initial Tₘₒₜₒᵣ. The method also includes determining a predicted hookload with the drillstring model based on the V_{TB}. The method also includes determining a current surface weight on bit (SWOB) with the mechanical model based on the predicted hookload and a hookload at zero WOB. The method also includes determining a predicted linear velocity (V_{Drum}) at a drum of the mechanical model with the mechanical model. The method also includes determining a current rate of penetration (ROP) with the mechanical model based on the predicted linear velocity at the drum (V_{Drum}). The method also includes operating the control model based on the current ROP and the current SWOB.

A computing system is also disclosed. The computing system includes one or more processors and a memory system. The memory system includes one or more non-transitory computer-readable media storing instructions that, when executed by at least one of the one or more processors, cause the computing system to perform operations for a rig hoisting model. The rig hoisting model includes a control model, a mechanical model, and a drillstring model operably coupled with one another. The operations include receiving input data at the control model. The operations also include determining an initial motor torque (Tₘₒₜₒᵣ) of the mechanical model with the control model based on the input data. The operations also include determining an initial hookload based on the drillstring model. The operations also include determining a velocity (V_{TB}) of a traveling block with the mechanical model based on the initial hookload and the initial Tₘₒₜₒᵣ. The operations also include determining a predicted hookload with the drillstring model based on the V_{TB}. The operations also include determining a current differential pressure ΔP of a downhole motor with the drillstring model. The operations also include determining a current surface weight on bit (SWOB) with the mechanical model based on the predicted hookload and a hookload at zero WOB. The operations also include determining a predicted linear velocity (V_{Drum}) at a drum of the mechanical model with the mechanical model. The operations also include determining a current rate of penetration (ROP) with the mechanical model based on the predicted linear velocity at the drum (V_{Drum}). The operations also include operating the control model based on the current ROP, the current SWOB, and the current differential pressure ΔP.

A non-transitory computer-readable medium is also disclosed. The medium stores instructions that, when executed by one or more processors of a computing system, cause the computing system to perform operations for a rig hoisting model. The rig hoisting model includes a control model, a mechanical model, and a drillstring model operably coupled with one another. The operations include receiving input data at the control model. The operations also include determining an initial motor torque (Tₘₒₜₒᵣ) of a drawwork of the mechanical model with the control model based on the input data. The operations also include directing the initial motor torque Tₘₒₜₒᵣ from the control model to the drawwork of the mechanical model. The operations also include determining an initial hookload based on the drillstring model. The operations also include directing the initial hookload from the drillstring model to the mechanical model. The operations also include determining a velocity (V_{TB}) of a traveling block with the mechanical model based on the initial hookload and the initial Tₘₒₜₒᵣ. The operations also include directing the V_{TB} to the drillstring model. The operations also include determining a predicted hookload with the drillstring model based on the V_{TB}. The operations also include determining a predicted surface torque with the drillstring model based on an RPM input of a top drive of the mechanical model. The operations also include determining a current differential pressure ΔP of a downhole motor with the drillstring model. The operations also include determining a current surface weight on bit (SWOB) with the mechanical model based on the predicted hookload and a hookload at zero WOB. The operations also include determining a predicted linear velocity (V_{Drum}) at a drum of the mechanical model with the mechanical model. The operations also include determining a current rate of penetration (ROP) with the mechanical model based on the predicted linear velocity at the drum (V_{Drum}). The operations also include directing the current rate of penetration (ROP) from the mechanical model to the control model. The operations also include operating the control model based on the current ROP, the current SWOB, the predicted surface torque, and the current differential pressure ΔP.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an exemplary rig hoisting system, according to an embodiment.

FIG. 3 illustrates a schematic diagram of an exemplary rig hoisting model and an associated workflow thereof, according to an embodiment.

FIG. 4 illustrates a schematic diagram of an exemplary control model and an associated workflow thereof, according to an embodiment.

FIG. 5 illustrates a schematic diagram of an exemplary mechanical model, according to an embodiment.

FIG. 6 illustrates a flowchart of a method for a rig hoisting model, according to an embodiment.

FIG. 7 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

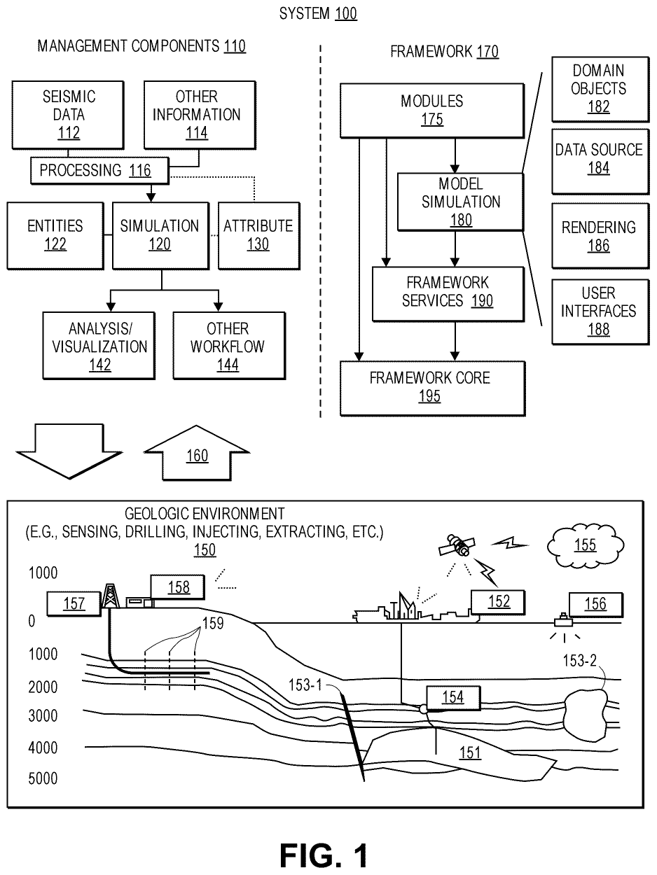

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY software (SLB, Houston, Texas). More particularly, SYMMETRY may process workflows in a single integrated environment with accurate thermodynamic fluid representation and consistent modeling across multiple disciplines including process, production, and HSE. The simulator integrates steady-state and transient (e.g., dynamic) analyses that can be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM (SLB, Houston, Texas). More particularly, PIPESIM is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

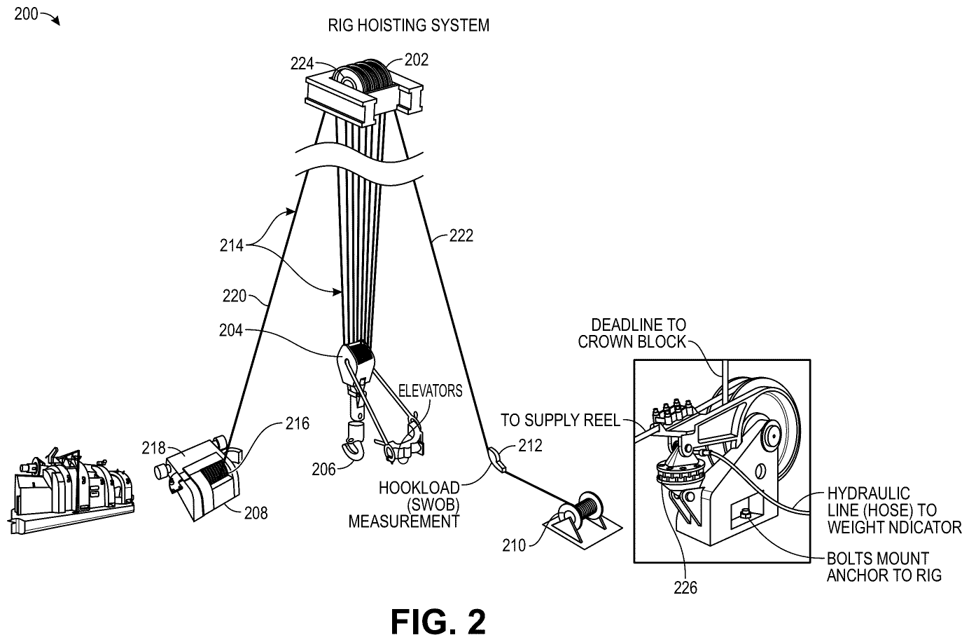

FIG. 2 illustrates an exemplary rig hoisting system 200, according to one or more embodiments disclosed herein. The rig hoisting system 200 may include one or more of a crown block 202, a traveling block 204, a drilling hook 206, a draw work 208, a reserve drum 210, a dead line anchor 212, drilling line 214, or any combination thereof, operably coupled with one another. For example, the rig hoisting system 200 may include the crown block 202, the traveling block 204, the drilling hook 206, the draw work 208, and the reserve drum 210, and the dead line anchor 212 operably coupled with one another via the drilling line 214, or any combination thereof. As illustrated in FIG. 2, a first end portion of fast line 220 of the drilling line 214 may be fastened to the draw work 208, and a second end portion 222 or dead line may be fastened or fixed to the dead line anchor 212. The draw work 208 may include a rotating drum 216 and a motor rotor 218 capable of or configured to rotate the rotating drum 216. The motor rotor 218 may rotate the rotating drum 216 to spool the drilling line 214 and control the movement of the drilling line 214 through the hoisting system 200. For example, the motor rotor 218 may control the spooling of the drilling line 214 from the rotating drum 216 to the dead line anchor 212 via the crown block 202 and the traveling block 204. The dead line anchor 212 may provide an anchoring point for a non-moving end of the drilling line 214. The dead line anchor 212 may include a load sensor 226 utilized to, capable of, or configured to determine a hookload (HKL), a weight on bit (e.g., a surface weight on bit), or any combination thereof. The crown block 202 may include a stationary set of pulleys or sheaves 224 configured to guide the drilling line 214 from the draw work 208 to the traveling block 204. The traveling block 204 may be a movable block including a set of pulleys configured to receive/guide the drilling line 214 and lower or raise the drilling hook 206 coupled therewith.

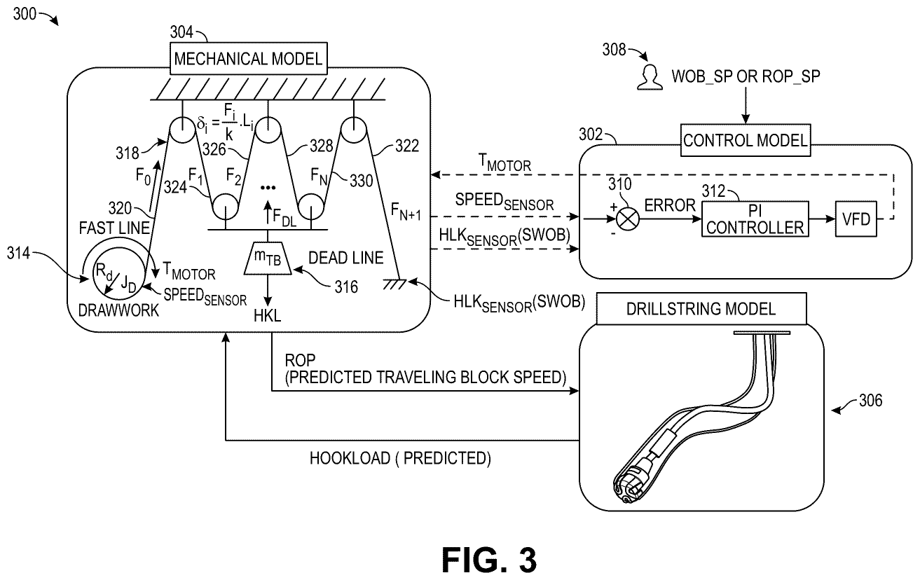

FIG. 3 illustrates a schematic diagram of an exemplary rig hoisting model 300 and an associated workflow thereof, according to one or more embodiments. The rig hoisting model 300 may be capable of or configured to simulate a rig hoisting system, such as the rig hoisting system 200 of FIG. 2. As illustrated in FIG. 3, the rig hoisting model 300 may include a control model/system 302, such as an autodriller, a mechanical model 304, and a drillstring model 306 operably coupled with one another. The control model 302 may include one or more comparators or error detectors 310 and one or more proportional (P) and integral (I) or PI controllers 312 operably coupled with one another. The control model 302 may be configured to receive input data and utilize the input data to operate, direct signals/commands to, and/or receive signals/commands from the mechanical model 304, the drillstring model 306, or any combination thereof. The mechanical model 304 may include a drawwork 314 and a traveling block 316 operably coupled with one another. The mechanical model 304 may include a drilling line 318. As illustrated in FIG. 3, the drilling line 318 may include a fast line 320, a dead line 322, one or more drilling lines (four are shown 324, 326, 328, 330), or any combination thereof. The drillstring model 306 may be or include, but is not limited to, a drilling mechanics simulation, a drilling mechanics simulation software, a drilling simulator, or any combination thereof. The drillstring model 306 may be capable of or configured to simulate a portion or an entire/full drillstring from a bit thereof to a surface (e.g., surface of the earth), and the mechanical model 304 and/or the control model 302 may be capable of or configured to simulate processes at the surface.

The input data may be from a user or operator 308, the mechanical model 304, the drillstring model 306, or any combination thereof. For example, the input data may be or include, but is not limited to, one or more setpoints from the operator 308, one or more signals and/or data (e.g., process variable) from the mechanical model 304, one or more signals and/or data (e.g., process variable) from the drillstring model 306, or any combination thereof. The one or more signals and/or data from the mechanical model 304, the drillstring model 305, or a combination thereof may be predicted or current data or variables. Illustrative input data may be or include, but is not limited to, one or more of a rate of penetration (ROP) setpoint, a weight-on-bit (WOB) setpoint, a torque setpoint, a differential pressure (ΔP) setpoint, an initial ROP condition, an initial WOB condition, an initial torque condition, an initial differential pressure (ΔP) condition, a predicted ROP condition, a predicted WOB condition, a predicted torque condition, a predicted differential pressure (ΔP) condition, a current ROP condition, a current WOB condition, a current torque condition, a current differential pressure (ΔP) condition, a motor torque (Tₘₒₜₒᵣ), a predicted hookload, a data from one or more sensors of the mechanical model 304 and/or the drillstring model 305, or any combination thereof. As used herein, the term “predicted” and/or “current” when used in conjunction with a variable (e.g., SWOB, ROP, etc.) may refer to the calculated value from the control model 302, the mechanical model 304, and/or the drillstring model 306, optionally, at a particular time (e.g., time=0, time=5, etc.). In at least some instances, the terms “predicted” and “current” may be used interchangeably as is known by those having ordinary skill in the art. For example, the predicted hookload may be the current hookload value calculated with the drillstring model 306. As used herein, the term “initial” when used in conjunction with a variable may refer to the calculated value from the control model 302, the mechanical model 304, and/or the drillstring model 306 at time=0 or time=1. The term “initial” when used in conjunction with a variable may also refer to an initial setpoint condition determined by the user or operator 308.

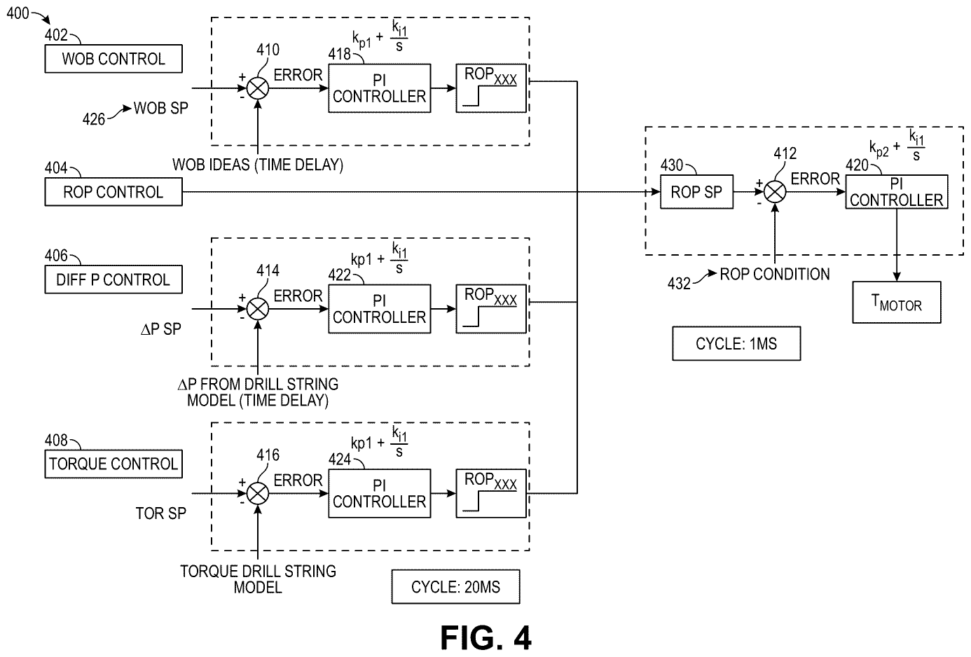

FIG. 4 illustrates a schematic diagram of an exemplary control model 400 and an associated workflow thereof, according to one or more embodiments. The control model 400 may include one or more control loops (for are shown 402, 404, 406, 408). For example, as illustrated in FIG. 4, the control model 400 may include a weight-on-bit (WOB) control loop 402, a rate of penetration (ROP) control loop 404, a differential pressure (ΔP) control loop 406, a torque control loop 408, or any combination thereof. As discussed above, the control model may include one or more comparators 310 and one or more PI controllers 312. For example, as illustrated and FIG. 4, each of the control loops 402, 404, 406, 408 may include a respective comparator 410, 412, 414, 416, respective PI controller 418, 420, 422, 424, or any combination thereof. Each of the comparators 410, 412, 414, 416 may receive input data, such as a respective setpoint and a current condition, and determine a respective differential or error between the respective setpoint and the current condition, and generate an error signal. Each of the comparators 410, 412, 414, 416 may direct the error signal to the respective PI controllers 418, 420, 422, 424. Each of the PI controllers may receive the error signal from the respective comparators 410, 412, 414, 416 and direct control signals (e.g., process variable or signals) to another control loop 402, 404, 406, 408, the mechanical model 304, the drillstring model 306, or any combination thereof. For example, as illustrated in FIG. 4, the WOB control loop 402 may receive input data, such as a WOB setpoint (SP) 426 and a WOB condition 428 (e.g., current WOB condition), at the comparator 410, generate an error signal at the comparator 410 with the WOB setpoint 426 and the WOB condition 428, and direct the error signal from the comparator 410 to the PI controller 418. The PI controller 418 of the WOB control loop 402 may receive the error signal, generate control signals, and direct the control signals to the ROP control loop 404. In another example, as illustrated in FIG. 4, the ROP control loop 404 may receive input data, such as a ROP setpoint (SP) 430 and a ROP condition 432 (e.g., current ROP condition), at the comparator 412, generate an error signal at the comparator 412, and direct the error signal from the comparator 412 to the PI controller 420. The PI controller 420 may receive the error signal, generate control signals, and direct the control signals to the mechanical model 304.

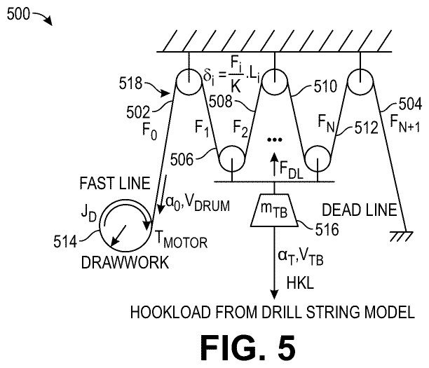

FIG. 5 illustrates a schematic diagram of an exemplary mechanical model 500, according to one or more embodiments. The mechanical model 500 may include a drawwork 514 and a traveling block 516 operably coupled with one another. The mechanical model 500 may include a drilling line 518. As illustrated in FIG. 5, the drilling line 518 may include a fast line 502, a dead line 504, one or more drilling lines (four are shown 506, 508, 510, 512), or any combination thereof. The tension force at the fast line 502 may be denoted as (F₀) and the tension force at the dead line 504 may be denoted as (F_{N+1}). The tension forces of the drilling lines may be denoted as Fᵢ (i=0 . . . . N+1).

In at least one embodiment, the tension force (F₀) of the fast line 502 may be determined according to equation (1):

$${\ddot{F}}_{0} {m}_{TB} {C}_{k} + {\dot{F}}_{0} ( N \cdot {C}_{d} + \frac{{R}_{d}^{2} {m}_{TB} c}{{J}_{D} k} ) + {F}_{0} ( N \cdot A + \frac{{R}_{d}^{2} {m}_{TB}}{{J}_{D}} ) = N \cdot W + \frac{{T}_{motor} {G}_{r} {R}_{d} {m}_{TB}}{{J}_{D}} , \qquad ( 1 )$$

where:

$${C}_{k} = \frac{{α}^{N} \cdot {L}_{N + 1}}{k} + {\sum }_{i = 0}^{N} \frac{{α}^{i} \cdot {L}_{i}}{k}$$

$${C}_{d} = {\sum }_{i = 1}^{N} \frac{{α}^{i} \cdot c}{k}$$

$$A = \frac{α - {α}^{n + 1}}{1 - α}$$

a total hookload on the traveling block (W) may be represented by: W=m_{TB}·g+HKL,
J_{D} may be an equivalent rotation moment related to a shaft of a drum of the drawwork 514 of the mechanical model 500,
Gᵣ may be a gear ratio of a gear box of the drawwork 514 of the mechanical model 500,
c may be a damping coefficient of the drilling line 518 of the mechanical model 500,
k may be a stiffness of the drilling line 518,
m_{TB} may be a mass of the traveling block 516 of the mechanical model 500,
HKL may be a predicted hookload from the drillstring model 306,
N may be a number of the drilling line 518 of the mechanical model 500,
Tₘₒₜₒᵣ may be a motor torque of the drawwork 514 of the mechanical model 500, and
R_{d} may be a radius of the drum of the drawwork 514.

As illustrated in FIG. 5, a linear acceleration (a₀) of the drilling line 518 may be reflected at the drawwork 514 of the mechanical model 500. The linear acceleration (a₀) at the drawwork 514 or the drum thereof may be positive in the downward direction. As further illustrated in FIG. 5, the acceleration (a_{T}) of the traveling block 516 may be positive in the upward direction. The acceleration (a₀) of the fast line 502 may be determined according to equation (2):

$${J}_{D} \frac{{a}_{0}}{{R}_{d}} = {T}_{motor} \cdot {G}_{r} - {R}_{d} \cdot ( {F}_{0} + c \frac{{\dot{δ}}_{0}}{{L}_{0}} ) \qquad ( 2 )$$

where:

$${J}_{D} = {J}_{drum} + {J}_{gear} + {G}_{r}^{2} \cdot {J}_{motor \_ rotor} + {R}_{d}^{2} \cdot {m}_{L} {\sum }_{i = 0}^{N / 2 - 1} ( {L}_{2 i} + {L}_{2 i + 1} ) ( 1 - \frac{2 i}{N} ) ,$$

J_{drum} may be a moment of inertia of the drum of the drawwork 514 of the mechanical model 500,
J_{gear} may be a moment of inertia of the gear box of the drawwork 514,
J_{motor_rotor} may be a moment of inertia of a motor rotor of the mechanical model 500,
m_{L} may be a mass of the drilling line 518 per unit length,
L₀ may be a length of the fast line 502,
R_{d} may be the radius of the drum,
N may be the number of the drilling lines 518.

It should be appreciated by one having ordinary skill in the art that equation (1) may be determined or solved numerically via the Newmark method. For example, equation (1) may be simplified via a variable or let-substitution as Equation (3):

C₀\ddot{F}₀+C₁\ddot{F}₀+C₂F₀=P (3)
where:

$${C}_{0} = {m}_{TB} {C}_{k} ; {C}_{1} = ( N \cdot {C}_{d} + \frac{{R}_{d}^{2} {m}_{TB} c}{{J}_{D} k} ) ,$$

$${C}_{2} = ( N \cdot A + \frac{{R}_{d}^{2} {m}_{TB}}{{J}_{D}} ) , and$$

$$P = N \cdot W + \frac{{T}_{motor} {G}_{r} {R}_{d} {m}_{TB}}{{J}_{D}} .$$

The values of

$${F}_{0}^{( n + 1 )} , {\dot{F}}_{0}^{( n + 1 )} , {\ddot{F}}_{0}^{( n + 1 )}$$

at time t=tₙ₊₁ may be calculated from values at time t=tₙ,

$${F}_{0}^{( n )} , {\dot{F}}_{0}^{( n )} , {\ddot{F}}_{0}^{( n )} .$$

The increment ΔP⁽ⁿ⁾ may be provided by the control model 302 and drillstring model 306. The value increment within one time step

$$Δ {F}_{0}^{( n )} , Δ {\dot{F}}_{0}^{( n )} , Δ {\ddot{F}}_{0}^{( n )}$$

may be evaluated according to equations (4), (5), and (6):

$${C}_{0} Δ {\ddot{F}}_{0}^{( n )} + {C}_{1} Δ {\dot{F}}_{0}^{( n )} + {C}_{2} Δ {F}_{0}^{( n )} = Δ {P}^{( n )} \qquad ( 4 )$$

$$Δ {\ddot{F}}_{0}^{( n )} = \frac{Δ {F}_{0}^{( n )}}{βΔ {t}^{2}} - \frac{{\dot{F}}_{0}^{( n )}}{βΔ t} - \frac{{\ddot{F}}_{0}^{( n )}}{2 β} \qquad ( 5 )$$

$$Δ {\dot{F}}_{0}^{( n )} = \frac{γΔ {F}_{0}^{( n )}}{βΔ t} - \frac{γ {\dot{F}}_{0}^{( n )}}{β} + Δ t ( 1 - \frac{γ}{2 β} ) {\ddot{F}}_{0}^{( n )} , \qquad ( 6 )$$

where:

$$β = \frac{1}{6} ; and$$

$$γ = \frac{1}{6} .$$

Substituting Equations (5) and (6) into Equation (4) provides Equation (7):

$$Δ {F}_{0}^{( n )} = \frac{{B}_{R}}{{B}_{L}} \qquad ( 7 )$$

where:

$${B}_{R} = Δ {P}^{( n )} + {\dot{F}}_{0}^{( n )} ( \frac{{C}_{0}}{βΔ t} + \frac{{C}_{1} γ}{β} ) + {\ddot{F}}_{0}^{( n )} [ \frac{{C}_{0}}{2 β} - {C}_{1} Δ t ( 1 - \frac{γ}{2 β} ) ] , and$$

$${B}_{L} = \frac{{C}_{0}}{βΔ {t}^{2}} + \frac{{C}_{1} γ}{βΔ t} + {C}_{2} .$$

Equation (7) may be substituted into Equations (5) and (6) to provide:

$$Δ {\ddot{F}}_{0}^{( n )} and Δ {\dot{F}}_{0}^{( n )} .$$

The next values of

$${F}_{0}^{( n + 1 )} , {\dot{F}}_{0}^{( n + 1 )} , {\ddot{F}}_{0}^{( n + 1 )}$$

at the next time step t=tₙ₊₁ may then be determined according to Equations (8), (9), and (10):

$${F}_{0}^{( n + 1 )} = {F}_{0}^{( n )} + Δ {F}_{0}^{( n )} \qquad ( 8 )$$

$${\dot{F}}_{0}^{( n + 1 )} = {\dot{F}}_{0}^{( n )} + Δ {\dot{F}}_{0}^{( n )} \qquad ( 9 )$$

$${\ddot{F}}_{0}^{( n + 1 )} = {\ddot{F}}_{0}^{( n )} + Δ {\ddot{F}}_{0}^{( n )} . \qquad ( 10 )$$

The fast line acceleration, the traveling block acceleration, and the traveling block velocity may then be determined according to Equations (11), (12), and (13), respectively:

$${J}_{D} \frac{{a}_{0}^{( n + 1 )}}{{R}_{d}} = {T}_{motor}^{( n + 1 )} \cdot {G}_{r} - {R}_{d} \cdot ( {F}_{0}^{( n + 1 )} + \frac{c {\dot{F}}_{0}^{( n + 1 )}}{k} ) \qquad ( 11 )$$

$${a}_{T}^{( n + 1 )} = ( {a}_{0}^{( n + 1 )} - {\ddot{F}}_{0}^{( n + 1 )} {C}_{k} ) / N \qquad ( 12 )$$

$${V}_{TB}^{( n + 1 )} = {V}_{TB}^{( n )} - [ {a}_{T}^{( n )} + {a}_{T}^{( n + 1 )} ] Δ t / 2 \qquad ( 13 )$$

The traveling block velocity

$$( {V}_{TB}^{( n + 1 )} )$$

may be utilized in the drillstring model 306 as the input data or ROP input data.

In an exemplary operation of the rig hoisting model 300, with continued reference to FIGS. 3 and 4, the control model 302 may receive input data. The input data may include one or more of the ROP setpoint, the WOB setpoint, the torque setpoint, the differential pressure (ΔP) setpoint, the initial ROP condition, the initial WOB condition, the initial torque condition, the initial differential pressure (ΔP) condition, or any combination thereof. The differential pressure (ΔP) may be a differential pressure (ΔP) of a downhole motor of the drillstring model 306. It should be appreciated that the differential pressure (ΔP) is separate from the incremental differential pressure (ΔP⁽ⁿ⁾) as expressed in Equation (4). The control model may determine a motor torque (Tₘₒₜₒᵣ) of the drawwork 314 of the mechanical model 304 based on the input data. For example, the motor torque (Tₘₒₜₒᵣ) may be determined with one or more of the ROP control 404, the WOB control 402, the torque control 408, the differential pressure (ΔP) control 406, or any combination thereof. Determining the motor torque (Tₘₒₜₒᵣ) may include one or more of: maintaining the initial ROP condition at or below the ROP setpoint with the ROP control 404, maintaining the initial WOB condition at or below the WOB setpoint with the WOB control 402, maintaining the initial torque condition at or below the torque setpoint with the torque control 408, maintaining the initial differential pressure (ΔP) condition at or below the differential pressure (ΔP) setpoint with the differential pressure (ΔP) control 406, or any combination thereof. The motor torque (Tₘₒₜₒᵣ) determined by the control model 302 may be directed to the mechanical model 304. For example, as illustrated in FIG. 3, the motor torque (Tₘₒₜₒᵣ) may be directed from the control model 302 to the drawwork 314 of the mechanical model 304. Particularly, the PI controller 312 of the control model 302 may output the torque setpoint to a variable frequency drive (VFD), and the VFD may translate the torque demand to electrical signals to control the drawwork 314 of the mechanical model 304.

In further operation, the drillstring model 306 or a drilling mechanics simulation thereof may direct a predicted hookload (HKL) to the mechanical model 304. The mechanical model 304 may determine a velocity (V_{TB}) of the traveling block 316 based on the predicted hookload from the drillstring model 306 and the motor torque (Tₘₒₜₒᵣ) from the control model 302. The velocity (V_{TB}) of the traveling block 316 may be directed from the mechanical model 304 to the drillstring model 306. The drillstring model 306 may determine the predicted hookload based on the velocity (V_{TB}) of the traveling block 316. The operation may further include determining a predicted surface torque with the drillstring model 306 based on a top drive, such as a top drive rotating the drillstring or a top drive of the mechanical model. For example, the drillstring model 306 may determine the predicted surface torque based on an RPM input of the top drive. The operation may also include determining a predicted differential pressure (ΔP) of a downhole motor with the drillstring model 306. The operation may also include determining a current surface weight on bit (SWOB) with the mechanical model 304 based on the predicted hookload (HKL) and a hookload at zero weight on bit. The predicted hookload may be based on a tension force (F_{N+1}) of the dead line 322 of the mechanical model 304. The tension force (F_{N+1}) of the dead line 322 may be determined with a tension force (F₀) of the fast line 320 and the acceleration (a₀) of the fast line 320 of the mechanical model 304. As noted above, the tension force (F₀) of the fast line 320 may be determined according to equation (1).

The operation of the rig hoisting model 300 may also include determining a predicted linear velocity (V_{Drum}) at a drum of the mechanical model 304. The predicted linear velocity (V_{Drum}) at the drum of the mechanical model 304 may be determined according to equation (14):

$${V}_{Drum}^{( n + 1 )} = {V}_{Drum}^{( n )} - [ {a}_{0}^{( n )} + {a}_{0}^{( n + 1 )} ] Δ t / 2 , \qquad ( 14 )$$

where Δt may be a change in time.

The operation of the rig hoisting model 300 may also include determining a current ROP with the mechanical model 304 based on the predicted linear velocity (V_{Drum}) at the drum. The operation may further include operating the control model 302 based on the current ROP, the current SWOB, the current surface torque, and the current differential pressure (ΔP). The operation may further include determining an updated motor torque with the control model 302 based on the current ROP, the current SWOB, the ROP setpoint, the WOB setpoint, additional input data, or any combination thereof. The operation may further include directing the updated motor torque from the control model to the mechanical model.

In at least one embodiment, the operation of the rig hoisting model 300 may include performing an action in response to any one of the foregoing steps of operating the rig hoisting model 300. The action may include operating a rig hoisting system based on the rig hoisting model 300. The action may include displaying any one or more of the motor torque (Tₘₒₜₒᵣ) of the drawwork 314 of the mechanical model 304, the predicted hookload from the drillstring model 306, the velocity (V_{TB}) of the traveling block 316, the predicted surface torque, the predicted differential pressure ΔP, the current surface weight on bit (SWOB), the hookload at zero WOB, the predicted linear velocity (V_{Drum}), the current rate of penetration (ROP), the updated motor torque Tₘₒₜₒᵣ, or any combination thereof.

### Exemplary Method

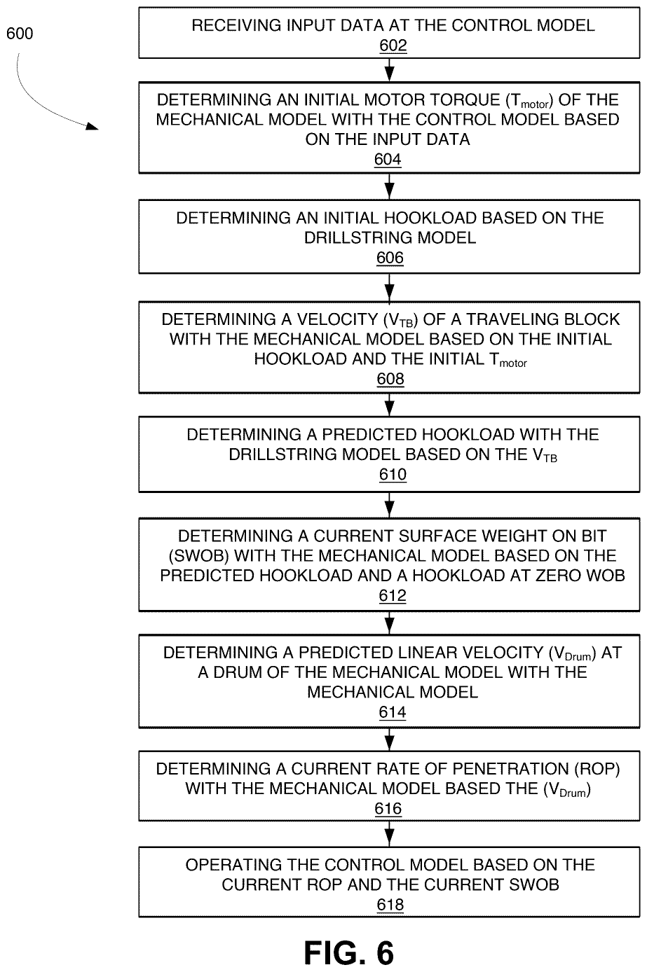

FIG. 6 illustrates a flowchart of a method 600 for a rig hoisting model, according to an embodiment. An illustrative order of the method 600 is provided below; however, one or more portions of the method 200 may be performed in a different order, simultaneously, repeated, or omitted. At least a portion of the method 200 may be performed using a computing system.

The method 600 may include receiving input data at the control model, as at 602.

The method 600 may also include determining an initial motor torque (Tₘₒₜₒᵣ) of the mechanical model with the control model based on the input data, as at 604.

The method 600 may also determining an initial hookload based on the drillstring model, as at 606.

The method 600 may also include determining a velocity (V_{TB}) of a traveling block with the mechanical model based on the initial hookload and the initial Tₘₒₜₒᵣ, as at 608.

The method 600 may also include determining a predicted hookload with the drillstring model based on the V_{TB}, as at 610.

The method 600 may also include determining a current surface weight on bit (SWOB) with the mechanical model based on the predicted hookload and a hookload at zero WOB, as at 612.

The method 600 may also include determining a predicted linear velocity (V_{Drum}) at a drum of the mechanical model with the mechanical model, as at 614.

The method 600 may also include determining a current rate of penetration (ROP) with the mechanical model based on the predicted linear velocity at the drum (V_{Drum}), as at 616.

The method 600 may also include operating the control model based on the current ROP and the current SWOB, as at 618.

The method 600 may also include displaying any one or more of the initial motor torque (Tₘₒₜₒᵣ), the predicted hookload, the velocity (V_{TB}) of the traveling block, the current differential pressure ΔP, the current surface weight on bit (SWOB), the hookload at zero WOB, the current rate of penetration (ROP), the predicted linear velocity (V_{Drum}), or any combination thereof.

The method 600 may also include performing an action in response to displaying any one or more of one or more of the initial motor torque (Tₘₒₜₒᵣ), the predicted hookload, the velocity (V_{TB}) of the traveling block, the current differential pressure ΔP, the current surface weight on bit (SWOB), the hookload at zero WOB, the current rate of penetration (ROP), the predicted linear velocity (V_{Drum}), or any combination thereof. The action may be or include generating and/or transmitting a signal that recommends, instructs, or causes a physical action to occur. The physical action may be or include operating a rig hoisting system based on the rig hoisting model. For example, the physical action may be or include operating a drillstring of the rig hoisting system based on the rig hoisting model. In another example, the physical action may be or include operating a drawwork of the rig hoisting system based on the rig hoisting model. In yet another example, the physical action may be or include operating an autodriller of the rig hoisting system based on the rig hoisting model.

### Exemplary Computing System

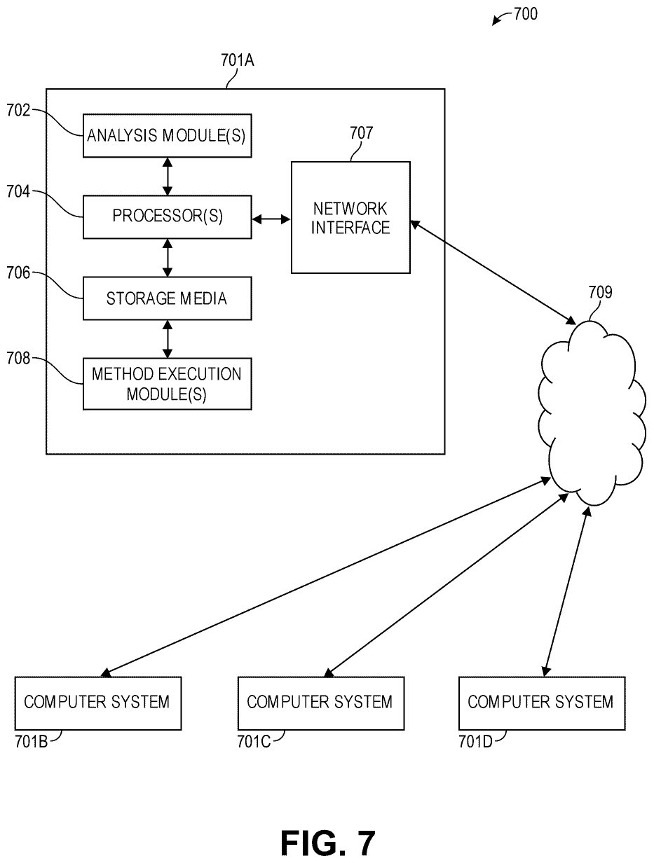

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more method execution module(s) 708. In the example of computing system 700, computer system 701A includes the method execution module 708. In some embodiments, a single method execution module may be used to perform some aspects of one or more embodiments of the methods disclosed herein. In other embodiments, a plurality of method execution modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for operating a rig hoisting model, the method comprising:
receiving input data;
determining an initial motor torque (Tₘₒₜₒᵣ) based on the input data;
determining an initial hookload based on a simulation of a drillstring;
determining a velocity (V_{TB}) of a traveling block based on the initial hookload and the initial Tₘₒₜₒᵣ,
determining a predicted hookload based on the V_{TB};
determining a current surface weight on bit (SWOB) based on the predicted hookload and a hookload at zero WOB;
determining a predicted linear velocity (V_{Drum}) at a drum based on a simulation of a rig hoisting system;
determining a current rate of penetration (ROP) based on the predicted linear velocity at the drum (V_{Drum}); and
operating the rig hoisting model based on the current ROP and the current SWOB.

2. The method of claim 1, further comprising:
determining a current differential pressure ΔP of a downhole motor with the simulation of the drillstring; and
operating the rig hoisting model based on the current ROP, the current SWOB, and the current differential pressure ΔP.

3. The method of claim 2, further comprising: displaying any one or more of the initial motor torque (Tₘₒₜₒᵣ), the predicted hookload, the velocity (V_{TB}) of the traveling block, the current differential pressure ΔP, the current surface weight on bit (SWOB), the hookload at zero WOB, the current rate of penetration (ROP), the predicted linear velocity (V_{Drum}), or any combination thereof.

4. The method of claim 3, further comprising performing an action in response to displaying any one or more of the initial motor torque (Tₘₒₜₒᵣ), the predicted hookload, the velocity (V_{TB}) of the traveling block, the current differential pressure ΔP, the current surface weight on bit (SWOB), the hookload at zero WOB, the current rate of penetration (ROP), the predicted linear velocity (V_{Drum}), or any combination thereof.

5. The method of claim 4, wherein the action comprises operating a rig hoisting system based on the rig hoisting model.

6. The method of claim 2, further comprising:
determining a predicted surface torque with the simulation of the drillstring, wherein the predicted surface torque is based on an RPM input of a top drive of the rig hoisting model; and
operating the rig hoisting model based on the current ROP, the current SWOB, and the predicted surface torque.

7. The method of claim 6, further comprising: displaying any one or more of the initial motor torque (Tₘₒₜₒᵣ), the predicted hookload, the velocity (V_{TB}) of the traveling block, the predicted surface torque, the current SWOB, the hookload at zero WOB, the current rate of penetration (ROP), or any combination thereof.

8. The method of claim 1, further comprising:
determining an updated motor torque Tₘₒₜₒᵣ based on the current ROP and the current SWOB; and
determining an updated velocity (V_{TB}) of the traveling block based on the predicted hookload and the updated motor torque Tₘₒₜₒᵣ.

9. The method of claim 8, further comprising:
determining an updated hookload based on the updated V_{TB}; and
determining an updated SWOB based on the updated hookload and the hookload at zero WOB.

10. The method of claim 9, further comprising:
determining an updated linear velocity (V_{Drum}) at the drum based on the simulation of the rig hoisting system;
determining an updated rate of penetration (ROP) based on the updated linear velocity at the drum (V_{Drum}); and
operating the rig hoisting model based on the updated ROP and the updated SWOB.

11. A computing system, comprising:
one or more processors; and
a memory system comprising one or more non-transitory computer-readable media storing instructions that, when executed by at least one of the one or more processors, cause the computing system to perform operations for a rig hoisting model, wherein the rig hoisting model comprises a control model, a mechanical model, and a drillstring model operably coupled with one another, the operations comprising:
receiving input data at the control model,
determining an initial motor torque (Tₘₒₜₒᵣ) of a drawwork of the mechanical model with the control model based on the input data,
determining an initial hookload based on the drillstring model;
determining a velocity (V_{TB}) of a traveling block with the mechanical model based on the initial hookload and the initial Tₘₒₜₒᵣ;
determining a predicted hookload with the drillstring model based on the V_{TB};
determining a current differential pressure ΔP of a downhole motor with the drillstring model;
determining a current surface weight on bit (SWOB) with the mechanical model based on the predicted hookload and a hookload at zero WOB;
determining a predicted linear velocity (V_{Drum}) at a drum of the mechanical model with the mechanical model;
determining a current rate of penetration (ROP) with the mechanical model based on the predicted linear velocity at the drum (V_{Drum}); and
operating the control model based on the current ROP, the current SWOB, and the current differential pressure ΔP.

12. The computing system of claim 11, wherein the input data comprises one or more of a ROP setpoint, a WOB setpoint, a torque setpoint, a ΔP setpoint, an initial ROP condition, an initial WOB condition, an initial torque condition, an initial ΔP condition, or any combination thereof.

13. The computing system of claim 11, wherein the control model comprises control loops, wherein the control loops comprise one or more of a rate of penetration (ROP) control loop, a weight on bit (WOB) control loop, a differential pressure (ΔP) control loop, a torque control loop, or any combination thereof.

14. The computing system of claim 11, wherein the operations further comprise:
directing the initial motor torque Tₘₒₜₒᵣ from the control model to the drawwork of the mechanical model;
directing the initial hookload from the drillstring model to the mechanical model;
directing the V_{TB} from the mechanical model to the drillstring model; and
directing the current rate of penetration (ROP) from the mechanical model to the control model.

15. The computing system of claim 11, wherein the operations further comprise:
determining a predicted surface torque with the drillstring model based on an RPM input of a top drive of the mechanical model; and
operating the control model based on the current ROP, the current SWOB, the predicted surface torque, and the current differential pressure ΔP.

16. A non-transitory computer-readable medium storing instructions that, when executed by one or more processors of a computing system, cause the computing system to perform operations for a rig hoisting model, wherein the rig hoisting model comprises a control model, a mechanical model, and a drillstring model operably coupled with one another, the operations comprising:
receiving input data at the control model;
determining an initial motor torque (Tₘₒₜₒᵣ) of a drawwork of the mechanical model with the control model based on the input data;
directing the initial motor torque Tₘₒₜₒᵣ from the control model to the drawwork of the mechanical model;
determining an initial hookload based on the drillstring model;
directing the initial hookload from the drillstring model to the mechanical model;
determining a velocity (V_{TB}) of a traveling block with the mechanical model based on the initial hookload and the initial Tₘₒₜₒᵣ;
directing the V_{TB} to the drillstring model;
determining a predicted hookload with the drillstring model based on the V_{TB};
determining a predicted surface torque with the drillstring model based on an RPM input of a top drive of the mechanical model;
determining a current differential pressure ΔP of a downhole motor with the drillstring model;
determining a current surface weight on bit (SWOB) with the mechanical model based on the predicted hookload and a hookload at zero WOB;
determining a predicted linear velocity (V_{Drum}) at a drum of the mechanical model with the mechanical model;
determining a current rate of penetration (ROP) with the mechanical model based on the predicted linear velocity at the drum (V_{Drum});
directing the current rate of penetration (ROP) from the mechanical model to the control model;
operating the control model based on the current ROP, the current SWOB, the predicted surface torque, and the current differential pressure ΔP.

17. The non-transitory computer-readable medium of claim 16, wherein:
the input data comprises one or more of an initial ROP condition, a ROP setpoint, an initial WOB condition, a WOB setpoint, an initial torque condition, a torque setpoint, an initial ΔP condition, an initial ΔP setpoint, or any combination thereof;
the control model comprises one or more control loops, wherein the control loops comprise one or more of a rate of penetration (ROP) control loop, a weight on bit (WOB) control loop, a differential pressure (ΔP) control loop, a torque control loop, or any combination thereof; and
the initial motor torque Tₘₒₜₒᵣ is determined with one or more of the ROP control loop, the WOB control loop, the ΔP control loop, the torque control, or any combination thereof, and wherein determining the initial motor torque Tₘₒₜₒᵣ comprises one or more of:
maintaining the initial ROP condition at or below the ROP setpoint with the ROP control loop;
maintaining the initial WOB condition at or below the WOB setpoint with the WOB control loop;
maintaining the initial torque condition at or below the torque setpoint with the torque control loop; and
maintaining the initial ΔP condition at or below the ΔP setpoint with the ΔP control loop.

18. The non-transitory computer-readable medium of claim 16, further comprising:
displaying any one or more of the initial motor torque (Tₘₒₜₒᵣ), the predicted hookload, the velocity (V_{TB}) of the traveling block, the predicted surface torque, the current differential pressure ΔP, the current surface weight on bit (SWOB), the hookload at zero WOB, the current rate of penetration (ROP), or any combination thereof; and
performing an action in response to displaying any one or more of the initial motor torque (Tₘₒₜₒᵣ), the predicted hookload, the velocity (V_{TB}) of the traveling block, the predicted surface torque, the current differential pressure ΔP, the current surface weight on bit (SWOB), the hookload at zero WOB, the current rate of penetration (ROP), or any combination thereof.

19. The non-transitory computer-readable medium of claim 16, wherein:
the predicted hookload is based on a tension force (F_{N+1}) of a dead line of the mechanical model, and wherein the tension force (F_{N+1}) of the dead line is determined with a tension force (F₀) of a fast line and an acceleration (a₀) of the fast line of the mechanical model, wherein:
the tension force (F₀) of the fast line is determined according to:
$${\ddot{F}}_{0} {m}_{TB} {C}_{k} + {\dot{F}}_{0} ( N \cdot {C}_{d} + \frac{{R}_{d}^{2} {m}_{TB} c}{{J}_{D} k} ) + {F}_{0} ( N \cdot A + \frac{{R}_{d}^{2} {m}_{TB}}{{J}_{D}} ) = N \cdot W + \frac{{T}_{motor} {G}_{r} {R}_{d} {m}_{TB}}{{J}_{D}} ,$$
wherein:
$${C}_{k} = \frac{{α}^{N} \cdot {L}_{N + 1}}{k} + {\sum }_{i = 0}^{N} \frac{{α}^{i} \cdot {L}_{i}}{k} ,$$
$${C}_{d} = {\sum }_{i = 1}^{N} \frac{{α}^{i} \cdot c}{k} ,$$
$$A = \frac{α - {α}^{n + 1}}{1 - α} ,$$
$$W = {m}_{TB} \cdot g + HKL ,$$
J_{D} is an equivalent rotation moment related to a shaft of a drum of the mechanical model,
Gᵣ is a gear ratio of a gear box of the mechanical model,
F₀ is the tension force of the fast line of the mechanical model,
c is a damping coefficient of a drilling line of the mechanical model,
k is a stiffness of the drilling line,
m_{TB} is a mass of the traveling block of the mechanical model,
HKL is the predicted hookload from the drillstring model,
N is a number of the drilling line of the mechanical model, and
R_{d} is a radius of the drum of the drawwork;
the acceleration (a₀) of the fast line is determined according to:
$${J}_{D} \frac{{a}_{0}}{{R}_{d}} = {T}_{motor} \cdot {G}_{r} - {R}_{d} \cdot ( {F}_{0} + c \frac{{\dot{δ}}_{0}}{{L}_{0}} ) ,$$
wherein:
Tₘₒₜₒᵣ is the motor torque,
$${J}_{D} = {J}_{drum} + {J}_{gear} + {G}_{r}^{2} \cdot {J}_{motor \_ rotor} + {R}_{d}^{2} \cdot {m}_{L} {\sum }_{i = 0}^{N / 2 - 1} ( {L}_{2 i} + {L}_{2 i + 1} ) ( 1 - \frac{2 i}{N} ) ,$$
J_{drum} is a moment of inertia of the drum of the mechanical model,
J_{gear} is a moment of inertia of the gear box,
J_{motor_rotor} is a moment of inertia of a motor rotor of the mechanical model,
m_{L} is a mass of the drilling line per unit length,
L₀ is a length of the fast line,
R_{d} is the radius of the drum, and
N is the number of the drilling lines.

20. The non-transitory computer-readable medium of claim 19, wherein the operations further comprise:
determining an updated motor torque Tₘₒₜₒᵣ with the control model based on the current ROP, the current SWOB, the current differential pressure ΔP, and the input data, wherein the input data comprises a ROP setpoint, a WOB setpoint, and a ΔP setpoint;
directing the updated Tₘₒₜₒᵣ from the control model to the mechanical model; and
operating a rig hoisting system based on the rig hoisting model.
